(19) United States
(12) Patent Application Publication
(10) Pub. No.: US 2014/0337125 A1
(43) Pub. Date: Nov. 13, 2014

(54) LEARN BUDGETING IN ONLINE ADVERTISING AUCTION EXCHANGES

(71) Applicant: AppNexus Inc., New York, NY (US)

(72) Inventors: John H. Dalto, Astoria, NY (US); David M. Himrod, New York, NY (US); Steven K. Kannan, New York, NY (US)

(21) Appl. No.: 14/213,754

(22) Filed: Mar. 14, 2014

Related U.S. Application Data
(60) Provisional application No. 61/782,955, filed on Mar. 14, 2013.

(51) Int. Cl. G06Q 30/02

(52) U.S. Cl. CPC G06Q 30/0249; G06Q 30/0254; G06Q 30/0275
USPC 705/14.48

(57) ABSTRACT

Method and system for optimizing impression bids for a real-time bidding advertising campaign. A set of nodes eligible to serve impressions for the advertising campaign is determined, and real-time bidding auctions are held for advertisements to be served on the set of eligible nodes. The auctions result in a desired number of success events being obtained without exceeding an budget. To determine the set of eligible nodes, a target set of nodes meeting targeting criteria for the advertising campaign is determined, delivery is forecasted for each target node, and the target nodes are ranked and filtered based at least in part on the forecasted deliveries.

### CROSS-REFERENCE TO RELATED APPLICATION

This application claims priority to and the benefit of U.S. Provisional Patent Application No. 61/782,955, filed on Mar. 14, 2013, and entitled “Learn Budgeting in Online Advertising Auction Exchanges,” the entirety of which is incorporated by reference herein.

### BACKGROUND INFORMATION

The present disclosure relates generally to optimizing bids in an online advertising real-time bidding system and, in particular, to a method and system for obtaining a sufficient number of positive impression auction results on a set of advertising venues without exceeding a budget amount.

In the online advertising space there is an abundance of supply. In other words, online advertisers have a wide selection of venues (e.g., websites) in which to display their advertisements. Because advertisements tend to be tailored to particular audiences, and venues tend to draw a particular type of audience, only a subset of the ads placed is likely to produce positive results for the advertisers and their campaigns. It is not always predictable, however, how a particular audience will react to an advertisement, or whether a particular venue will attract a desired target audience. Because of this, there is a substantial challenge in identifying the subset of desirable venues without prematurely exhausting an advertising budget.

This problem is exacerbated in the context of real-time bidding for advertising impressions. Advertisers must ensure that the bids they submit are well-tailored to reach the target audience, as well as low enough to ensure a return on investment. When a new advertising campaign is launched, however, there may be inadequate data to form such optimized bids. Further, even if an advertiser desires to “test the waters” by bidding in various impression auctions, there is no guarantee that statistically significant information will be derived that would allow the advertiser to calculate an optimal bid. Accordingly, there is a need for techniques to select a set of venues that makes efficient use of an advertising budget and ensure that sufficient data will be gathered from impression auctions on those venues to form an optimized bid value.

### SUMMARY

A method and system for optimizing impression bids for a real-time bidding advertising campaign is described. In one aspect, a computer-implemented method includes determining a set of nodes eligible to serve impressions for a real-time bidding advertising campaign; and participating in a plurality of real-time bidding auctions for advertisements to be served on the set of eligible nodes, the auctions resulting in a desired number of success events (e.g., clicks and/or conversions) being obtained without exceeding a budget.

In one implementation, determining the set of eligible nodes includes: determining a target set of nodes meeting targeting criteria for the advertising campaign; ranking the nodes in the target set; and filtering the ranked nodes to produce the set of eligible nodes. Filtering the ranked nodes can include selecting a number of the highest ranking nodes for inclusion in the set of eligible nodes.

In another implementation, the method further includes forecasting delivery for each node in the target set. The nodes in the target set can be ranked by at least one of delivery, margin, and expected revenue. The filtering can be based at least in part on the forecasted delivery of each node in the target set. The forecasting can be based at least in part on a calculated bid value for one or more impressions to be served on the node.

In a further implementation, participating in the real-time bidding auctions includes determining that the budget is being spent too quickly and removing at least one node from the set of eligible nodes. Participating in the real-time bidding auctions can also include determining that the budget is being spent too slowly and adding at least one node to the set of eligible nodes.

In another aspect, a system includes one or more computers programmed to perform operations including determining a set of nodes eligible to serve impressions for the a real-time bidding advertising campaign; and participating in a plurality of real-time bidding auctions for advertisements to be served on the set of eligible nodes, the auctions resulting in a desired number of success events (e.g., clicks and/or conversions) being obtained without exceeding an budget.

In one implementation, determining the set of eligible nodes includes: determining a target set of nodes meeting targeting criteria for the advertising campaign; ranking the nodes in the target set; and filtering the ranked nodes to produce the set of eligible nodes. Filtering the ranked nodes can include selecting a number of the highest ranking nodes for inclusion in the set of eligible nodes.

In another implementation, the operations further include forecasting delivery for each node in the target set. The nodes in the target set can be ranked by at least one of delivery, margin, and expected revenue. The filtering can be based at least in part on the forecasted delivery of each node in the target set. The forecasting can be based at least in part on a calculated bid value for one or more impressions to be served on the node.

In a further implementation, participating in the real-time bidding auctions includes determining that the budget is being spent too quickly and removing at least one node from the set of eligible nodes. Participating in the real-time bidding auctions can also include determining that the budget is being spent too slowly and adding at least one node to the set of eligible nodes.

The details of one or more implementations of the subject matter described in the present specification are set forth in the accompanying drawings and the description below. Other features, aspects, and advantages of the subject matter will become apparent from the description, the drawings, and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the implementations. In the following description, various implementations are described with reference to the following drawings, in which:

FIG. 1 is a diagram illustrating by example a high-level process for selecting an eligible set of nodes according to an implementation.

FIG. 2 is a diagram illustrating by example a detailed process for selecting an eligible set of nodes according to an implementation.

### DETAILED DESCRIPTION

The effectiveness of an advertising campaign implemented over a real-time bidding (RTB) online advertising platform can be measured using various types of performance metrics (e.g., return on investment (ROI)). To maximize ROI, it is desirable to display creatives of an advertising campaign on impression inventory that allows for a sufficient number of auction wins and, optionally, a sufficient number of success events (e.g., clicks, conversions) to occur while satisfying various constraints (e.g., overall campaign budget, daily min-/max-budget spend, budget over time, etc.). In this sense, the goal is to optimize an advertiser's bidding strategy so that the advertiser does not spend more than necessary to obtain success events.

When an advertising campaign is first established on the advertising platform, the advertiser may have little or no knowledge about how that campaign will perform. Thus, to attain bid value optimization, the platform can include a “learning mode,” such as that described in U.S. patent application Ser. No. 13/561,855, filed Jul. 30, 2012, and entitled “Targeted Learning in Online Advertising Auction Exchanges,” the entirety of which is incorporated by reference herein. In learning mode, data is gathered on the performance of the campaign (measured as cost-per-mille, cost-per-click, or cost-per-acquisition) for a unique combination of a campaign, venue, and creative size (collectively referred to herein as a “node”). In other implementations, however, a “node” can be a unique combination of various advertising attributes associated with an impression to be served, including, but not limited to, advertiser, campaign, venue, creative size, and/or creative.

The campaign reaches a “confidence threshold” and learning mode completes when a desired number of success events (e.g., view-through events, click events, click-through events, and/or other type of conversion event) occurs. Because the optimization process is based on combinations of campaign, venue, and creative, it is generally not recommended for an advertising campaign to dilute its budget over a large number of nodes in learning mode. More specifically, the budget should be allocated over a small enough subset of the nodes so that enough impressions are served per node (thereby increasing the statistical accuracy of a success events to impressions ratio), but not so small that there is low confidence in the results achieved.

As used herein, “eligibility” refers to the selection of a subset of nodes for use by a RTB campaign in learning mode. The eligibility process determines a set of nodes that allows a campaign to efficiently spend a learning budget, rather than spreading the budget too thinly over a universe of venues. In other words, the process attempts to select nodes that have a reasonable chance of producing enough success events (e.g., clicks, conversions) so that the campaign can exit the learning phase of the campaign and enter into an optimized bidding mode.

As used herein, an “eligible node” refers to a node permitted to serve impressions when in learning mode. The term “eligible set” is defined as the set of nodes that are enabled as eligible and that will be used for learning by a campaign. Although the description of the eligibility process herein involves selecting nodes for campaign learning, it should be appreciated that the process can create an eligible set based on advertisers, campaigns, creative sizes, venues, creatives, or other advertising attributes, for learning by a campaign, advertiser, or other advertising activity or entity.

Eligibility can be implemented at the campaign level, meaning that each RTB campaign is considered in isolation. In order to determine the eligible nodes for the campaign, various different processes can be used including those described herein, although fewer or additional steps can be included in such processes, or, in some cases, the steps can be ordered differently. One skilled in the art will recognize the various modifications that can be made to the eligibility process while still producing the desired result of an eligibility set.

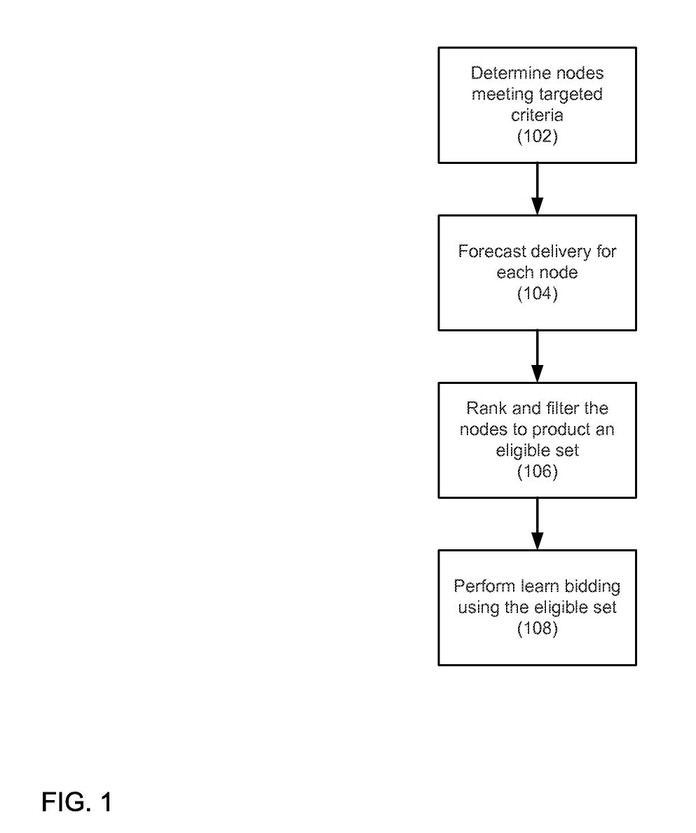

Referring to FIG. 1, in one implementation, a high-level method for selecting a set of eligible nodes includes the steps below.

Step One (102): Determine a set of nodes that meets targeting criteria for a campaign. This set comprises the nodes on which a campaign can serve impressions given the targeting parameters of the campaign. Targeting criteria can include various criteria useful for selecting a target advertising audience, such as geography, age range, income level, whitelists, blacklists, and so on. Each node has associated metrics, such as how many impressions have already been served, how many impressions are necessary to become optimized, and how much revenue will be produced. These metrics can be used in calculations to further refine the initial eligibility set.

Step Two (104): Forecast delivery for each node in the targeted set. This refers to predicting the number of impressions to be delivered to each node based on, for example, the calculated bid amount for one or more impressions to be served on the node. The bid amount can be determined based on an a break-even bid value and an advertiser's desired profit margin. In one example, the break-even bid value is $1.00 cost per mille (cpm), and the desired profit margin is 20%. The calculated bid for forecasting delivery would therefore be $1.00−(20%*$1.00)=$0.80 cpm.

Step Three (106): Rank and filter the nodes in the targeted set to produce an eligible set. Based on the forecasted deliveries calculated for each node in the previous set, a reduced set of nodes is determined that allows for the advertiser's learn budget to be optimally or near-optimally spent while gathering the number of success events necessary to optimize the campaign. The nodes can be selected for inclusion in the eligible set based on their ranking with respect to other nodes, and the number of nodes permitted in the eligible set can be limited by the available learning budget. The nodes can be ranked on one or more goals of the advertiser, such as delivery, margin, revenue, and the like.

Step Four (108): Perform learn bidding using the eligible set. Bids are placed for impressions to be served on the nodes in the eligible set. While the campaign is in learn mode, further modifications can be made to the eligible set based on the rate at which the advertising budget is being spent. If, for example, the delivery forecasts for the nodes in the set were too high (i.e., fewer impressions auctions are won than expected), additional nodes can be added to the eligible set to increase the rate at which the budget is used. If, on the other hand, the delivery forecasts were too low (i.e., too many ads are served, causing the budget to be used too quickly), nodes can be removed from the eligible set.

In one implementation, forecasting the delivery of a node involves an analysis of market data for the online advertising platform and the computation of price curve functions across each venue. From these functions, an estimation can be derived for how much to modify a bid value to reach a target delta in impressions delivered. For example, if a bid value of $0.50 is predicted to win 25% of impression auctions on a set of nodes, but a threshold of 30% is required to obtain the necessary number of success events to exit learning mode, then the analytics functionality can be used to determine that, for instance, an increase in the bid value to $0.55 will allow the 30% threshold to be attained.

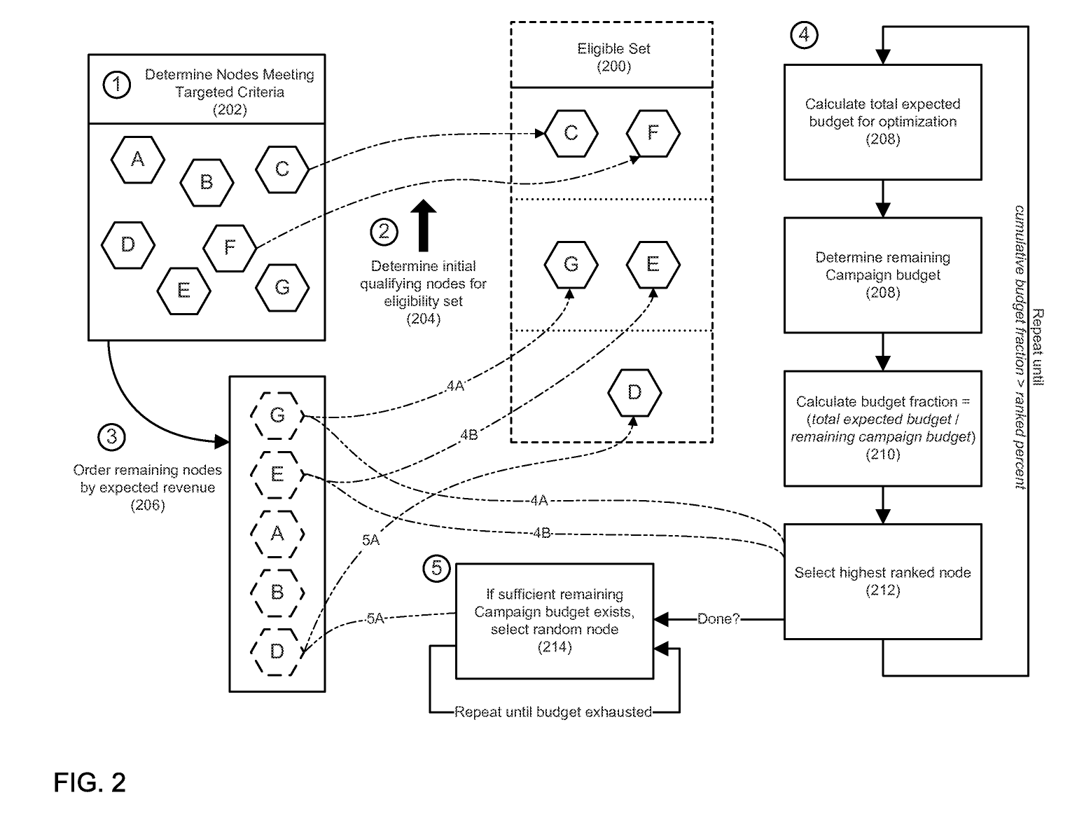

Referring to FIG. 2, in another implementation, a method for selecting a set of eligible nodes 200 includes the steps described below. However, these steps constitute only one non-limiting example of a process for forming an eligibility set. Other implementations are contemplated, as one skilled in the art will appreciate.

Step One (202): For a given campaign, all nodes that meet targeting criteria are selected (nodes A-G, as shown), and their values for impressions served, buyside expected revenue, expected impressions to optimized, and buyside_eligible are gathered. The impressions served value refers to the total number of impressions that the node has served. Buyside expected revenue refers to the amount of revenue the node is expected to make. Expected impressions to optimized refers to the number of impressions that the node would have to serve to gain enough success events to become optimized. The buyside_eligible value is a flag indicating whether the node is in an eligible set for use by a learning campaign.

Step Two (204): Any nodes for which impressions served is less than expected impressions to optimized (nodes C and F, as shown) are automatically added to the eligible set 200, provided that their expected impressions to optimized value is less than the median expected impressions to optimized. In other implementations, however, all nodes for which impressions served is less than expected impressions to optimized divided by a configurable value are added to the eligible set 200.

Step Three (206): The remaining nodes (nodes A, B, D, E, and G) are ordered based on the buyside expected revenue for each node. In other implementations, the remaining nodes are ordered based on revenue, profit, various user preferences, profit floor, and/or combinations of the foregoing.

Step Four (208): The expected budget that each node would consume in order to become optimized is calculated. If the budget is measured in dollars or another currency denomination, it is calculated as expected impressions to optimized*buyside expected revenue. If the budget is instead measured in impressions, the expected impressions to optimized value for the node is used as the budget.

Step Five (208): The total expected budget for the nodes in the eligible set 200 is subtracted from the total campaign budget (described below). If there is leftover budget remaining, that amount can be used to add further nodes to the eligible set 200, if any.

Step Six (210): An expected budget_fraction value is calculated for the remaining nodes (i.e., those nodes not selected for the eligible set) by dividing the expected budget of the remaining nodes by the remaining budget determined in Step Four.

Step Seven (212): Starting with the remaining node having the highest buyside expected revenue (or other applicable ranking parameter) and continuing in decreasing order, remaining nodes are iteratively selected (nodes G and E, as shown) for inclusion in the eligible set 200 until the budget_fraction is greater than a predetermined ranked_percent variable, which can be a configuration parameter. After a venue is selected twice for the eligible set 200 (e.g., selected for two different creatives), it can no longer be added to the set 200 based on buyside expected revenue.

Step Eight (214): Following the selection of ranked nodes, the remaining budget amount, if any, is consumed by randomly selecting nodes (node D) to add to the eligible set 200. Venues can be selected any number of times in this step. Random nodes are included in the eligible set 200 to produce variety in the nodes selected for learning, as well as to discover potentially valuable venues that may have high conversion rates but thus far have inadequate impression performance data to reflect the true rates.

Step Nine: After proceeding through the previous steps, if the eligible set 200 does not include a single node (e.g., because every node's expected budget exceeds the campaign budget), the node having the highest expected revenue value is added to the set 200.

Step Ten: The eligible set 200 (including nodes C, D, E, F, and G) is complete, the nodes contained within are considered to be buyside_eligible, and the campaign is able to use these nodes for targeted learning.

Ultimately, the eligible set should include those venues likely to provide the number of success events necessary to exit learning mode, but not likely to prematurely exhaust a learn budget. Determining the eligible set can therefore implicate tradeoffs between optimal performance, such that the desired number of success events is attained in learn mode, and optimal delivery, such that a high level of confidence exists in the learn results because the learn budget has been sufficiently utilized over a desirable set of venues.

As described with respect to the eligibility process, the campaign budget is generally the total budget a campaign has for targeted learning on a given day, although other time periods can be used as appropriate. In some instances, campaigns have a configured daily campaign learn budget; however, in other circumstances, campaigns can use different representations of a budget. Thus, one way to determine a daily learn budget is to convert an existing budget into daily form. In one implementation, the daily learn budget is chosen as the first available of the following budget measures:

1. Campaign daily learn budget

2. Campaign lifetime learn budget/days in lifetime

3. Campaign daily budget

4. Campaign lifetime budget/days in lifetime

5. Line item daily budget

6. Line item lifetime budget/days in lifetime

7. No daily budget (no nodes are eligible to learn).

In practice, the above-described eligibility process can lead to a considerable amount of “churn,” meaning that the eligible set of venues that falls within the budget constraints changes very rapidly. If the amount of churn is large, it can defeat the purpose of the eligibility process, which is to target the learn budget toward a subset of high-expected-value nodes. With too much churn, the learn budget will instead be too thinly spread around the entire node space, and the results necessary for optimization are less likely to be gained.

Churn can arise from several sources. For example, churn can occur on account of the selection of random nodes as a fraction of each eligibility set. Because this set of random nodes can be reselected periodically (e.g., every 15 minutes, 1 hour, 3 hours, or other suitable period), there is at least as much churn as there is randomness. The rate of churn can also be affected by the addition of new nodes made available for learning.

In some implementations, churn is caused by updates in node performance data. Because nodes that are selected as eligible can accrue real impressions in production, their ranks can change considerably by the next eligibility iteration. In contrast, ranks of nodes that do not accrue impressions can vary much less. As a result, each time an eligible set is created, the selected nodes can be different. In particular, because optimization data is gained based on actions that have a low probability of occurring, it is possible that a node will accrue impressions but no success events in between eligibility iterations, and will thus decrease in rank and rotate out of the eligible set, having never had a real chance to prove its value.

Although a high rate of churn can be harmful to the eligibility process, the value of churn is that it allows the system to rotate underperforming nodes out of eligibility if they fail to live up to their expected values. Therefore, in some implementations, the eligibility process is further refined to reduce the churn rate, while still allowing rapid rotation when appropriate.

To suitably limit the churn rate, a node that was eligible in the previous eligibility selection set can be automatically added to the new eligibility set if it has not yet run for some minimum number of impressions. For example, in some implementations the minimum number of impressions needed to remove a node is calculated as 2/p impressions (where p is the expected action rate of the node, meaning that one event for the node is expected per 1/p impressions served by the node) and it does not have an expected impressions to optimize value above the median for that campaign. If the node has exceeded 2/p impressions, it is not necessarily barred from the eligible set as it still can be selected randomly or due to a high ranking. This can include nodes that may have experienced one or more success events. Nodes with expected impressions to optimize greater than the median are not automatically added to the eligible set because such nodes have large values of p and lower expected values. In most cases, it would be unproductive to spend disproportionate impression volume on lower valued nodes. Once added to the eligible set, a node meeting the above requirements continues to consume budget for the remaining eligibility calculations. In some implementations, the node can be added to the eligible set even if adding it causes the eligible set to exceed the learning budget.

Implementations of the system described herein can use appropriate hardware or software; for example, the system can execute on hardware capable of running an operating system such as the Microsoft Windows® operating systems, the Apple OS X® operating systems, the Apple iOS® platform, the Google Android™ platform, the Linux® operating system and other variants of UNIX® operating systems, and the like.

Some or all of the functionality described herein can be implemented in software and/or hardware. Such hardware can include, but is not limited to, a smart phone, smart watch, smart glasses, tablet computer, portable computer, television, gaming device, music player, mobile telephone, laptop, palmtop, smart or dumb terminal, network computer, personal digital assistant, wireless device, information appliance, workstation, minicomputer, mainframe computer, or other computing device, that is operated as a general purpose computer or a special purpose hardware device that can execute the functionality described herein. The software, for example, can be implemented on a general purpose computing device in the form of a computer including a processing unit, a system memory, and a system bus that couples various system components including the system memory to the processing unit.

Additionally or alternatively, some or all of the functionality can be performed remotely, in the cloud, or via software-as-a-service. For example, certain functions can be performed on one or more remote servers or other devices that communicate with client devices. The remote functionality can execute on server class computers that have sufficient memory, data storage, and processing power and that run a server class operating system (e.g., Oracle® Solaris®, GNU/Linux®, and the Microsoft® Windows® family of operating systems).

The system can include a plurality of software processing modules stored in a memory and executed on a processor. By way of illustration, the program modules can be in the form of one or more suitable programming languages, which are converted to machine language or object code to allow the processor or processors to execute the instructions. The software can be in the form of a standalone application, implemented in a suitable programming language or framework.

Method steps of the techniques described herein can be performed by one or more programmable processors executing one or more computer programs to perform functions by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors. Generally, a processor will receive instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store media assets (e.g., audio, video, graphics, interface elements, and/or other media files), configuration files, and/or instructions that, when executed by a processor, form the modules, engines, and other components described herein and perform the functionality associated with the components. The processor and the memory can be supplemented by, or incorporated in special purpose logic circuitry.

A communications network can connect client devices with one or more remote servers and/or with each other. The communication can take place over media such as standard telephone lines, LAN or WAN links (e.g., T1, T3, 56 kb, X.25), broadband connections (ISDN, Frame Relay, ATM), wireless links (802.11 (Wi-Fi), Bluetooth, GSM, CDMA, etc.), for example. Other communication media are possible. The network can carry TCP/IP protocol communications, and HTTP/HTTPS requests made by a web browser, and the connection between the client devices and servers can be communicated over such TCP/IP networks. Other communication protocols are possible.

In various implementations, a client device includes a web browser, native application, or both, that facilitates execution of the functionality described herein. A web browser allows the device to request a web page or other downloadable program, applet, or document (e.g., from the remote server(s) or other server, such as a web server) with a web page request. One example of a web page is a data file that includes computer executable or interpretable information, graphics, sound, text, and/or video, that can be displayed, executed, played, processed, streamed, and/or stored and that can contain links, or pointers, to other web pages. In one implementation, a user of the client device manually requests a web page from the server. Alternatively, the device automatically makes requests with the web browser. Examples of commercially available web browser software include Microsoft® Internet Explorer®, Mozilla® Firefox®, and Apple® Safari®.

In some implementations, the client devices include client software. The client software provides functionality to the device that provides for the implementation and execution of the features described herein. The client software can be implemented in various forms, for example, it can be in the form of a native application, web page, widget, and/or Java, JavaScript, .Net, Silverlight, Flash, and/or other applet or plug-in that is downloaded to the device and runs in conjunction with the web browser. The client software and the web browser can be part of a single client-server interface; for example, the client software can be implemented as a plug-in to the web browser or to another framework or operating system. Other suitable client software architecture, including but not limited to widget frameworks and applet technology can also be employed with the client software.

The system can also be practiced in distributed computing environments where tasks are performed by remote processing devices that are linked through a communications network. In a distributed computing environment, program modules can be located in both local and remote computer storage media including memory storage devices. Other types of system hardware and software than that described herein can also be used, depending on the capacity of the device and the amount of required data processing capability. The system can also be implemented on one or more virtual machines executing virtualized operating systems such as those mentioned above, and that operate on one or more computers having hardware such as that described herein.

In some cases, relational or other structured databases can provide such functionality, for example, as a database management system which stores data for processing. Examples of databases include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

It should also be noted that implementations of the systems and methods can be provided as one or more computer-readable programs embodied on or in one or more articles of manufacture. The program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The terms and expressions employed herein are used as terms and expressions of description and not of limitation, and there is no intention, in the use of such terms and expressions, of excluding any equivalents of the features shown and described or portions thereof. In addition, having described certain implementations of the invention, it will be apparent to those of ordinary skill in the art that other implementations incorporating the concepts disclosed herein can be used without departing from the spirit and scope of the invention. The features and functions of the various implementations can be arranged in various combinations and permutations, and all are considered to be within the scope of the disclosed invention. Accordingly, the described implementations are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

1. A computer-implemented method comprising:
determining a set of eligible nodes on which to serve impressions for an advertising campaign based on a likelihood that the eligible nodes will produce a combined desired number of success events over a plurality of real-time bidding auctions without exceeding a maximum advertising budget, wherein a particular eligible node comprises a unique combination of advertising elements, wherein determining the set of eligible nodes comprises:
identifying a set of target nodes that meets targeting criteria for the advertising campaign,
predicting a respective number of impressions to be delivered to each of the target nodes, and
selecting the set of eligible nodes from the set of target nodes based at least in part on the predicting; and
participating in a plurality of real-time bidding auctions for impressions to be served on the set of eligible nodes.

2. The method of claim 1, wherein determining the set of eligible nodes further comprises:
ranking the target nodes based on an advertiser goal; and
filtering the ranked target nodes based at least in part on the advertising budget.

3. The method of claim 2, wherein filtering the ranked target nodes comprises selecting a number of highest ranking target nodes for inclusion in the set of eligible nodes.

4. (canceled)

5. The method of claim 2, wherein the advertiser goal comprises at least one of delivery, margin, and expected revenue.

6. The method of claim 2, wherein the filtering is based at least in part on the respective predicted impressions of each target node.

7. The method of claim 1, wherein the predicting for a particular target node is based at least in part on a calculated bid value for one or more impressions to be served on the particular target node.

8. The method of claim 1, wherein the success events are selected from the group consisting of clicks and conversions.

9. The method of claim 1, wherein participating in the real-time bidding auctions comprises determining that the budget is being spent too quickly and removing at least one node from the set of eligible nodes.

10. The method of claim 1, wherein participating in the real-time bidding auctions comprises determining that the budget is being spent too slowly and adding at least one node to the set of eligible nodes.

11. A system comprising:
one or more computers programmed to perform operations comprising:
determining a set of eligible nodes on which to serve impressions for an advertising campaign based on a likelihood that the eligible nodes will produce a combined desired number of success events over a plurality of real-time bidding auctions without exceeding a maximum advertising budget, wherein a particular eligible node comprises a unique combination of advertising elements, wherein determining the set of eligible nodes comprises:
identifying a set of target nodes that meets targeting criteria for the advertising campaign,
predicting a respective number of impressions to be delivered to each of the target nodes, and
selecting the set of eligible nodes from the set of target nodes based at least in art on the predicting; and
participating in a plurality of real-time bidding auctions for impressions to be served on the set of eligible nodes.

12. The system of claim 11, wherein determining the set of eligible nodes further comprises:
ranking the target nodes based on an advertiser goal; and
filtering the ranked target nodes based at least in part on the advertising budget.

13. The system of claim 12, wherein filtering the ranked target nodes comprises selecting a number of highest ranking target nodes for inclusion in the set of eligible nodes.

14. (canceled)

15. The system of claim 12, wherein the advertiser goal comprises at least one of delivery, margin, and expected revenue.

16. The system of claim 12, wherein the filtering is based at least in part on the respective predicted impressions of each target node.

17. The system of claim 11, wherein the predicting for a particular target node is based at least in part on a calculated bid value for one or more impressions to be served on the particular target node.

18. The system of claim 11, wherein the success events are selected from the group consisting of clicks and conversions.

19. The system of claim 11, wherein participating in the real-time bidding auctions comprises determining that the budget is being spent too quickly and removing at least one node from the set of eligible nodes.

20. The system of claim 11, wherein participating in the real-time bidding auctions comprises determining that the budget is being spent too slowly and adding at least one node to the set of eligible nodes.

21. The method of claim 1, wherein the advertising elements comprise at least one of an advertiser, a campaign, a creative size, a venue, and a creative.

22. The system of claim 11, wherein the advertising elements comprise at least one of an advertiser, a campaign, a creative size, a venue, and a creative.
